(19) United States
(12) Patent Application Publication
(10) Pub. No.: US 2018/0328534 A1
(43) Pub. Date: Nov. 15, 2018

(54) COMPATIBLE ROBOTIC ARM

(71) Applicant: Vishnu Vardhan CHAKRAVARAM, Edison, NJ (US)

(72) Inventor: Vishnu Vardhan CHAKRAVARAM, Edison, NJ (US)

(21) Appl. No.: 15/976,846

(22) Filed: May 10, 2018

Related U.S. Application Data
(60) Provisional application No. 62/504,410, filed on May 10, 2017.

(51) Int. Cl. F16M 11/20; B25J 18/00; B25J 17/02; A47B 23/00

(52) U.S. Cl. CPC F16M 11/2035; A47B 23/00; B25J 17/0241; B25J 18/00

(57) ABSTRACT

A composite structure and article of manufacture for a composite structure arranged with a rotatable top are disclosed.

In various embodiments, the composite structure is disclosed with improved angles of freedom and ability to be adjusted in multiple positions along six (6) axes, while all the six (6) axes are independent of each other, this provision indeed helps the user to have the composite structure adjusted in every angle that is comfortable for the user.

This application claims the benefit to U.S. Provisional Application No. 62/504,410, filed on May 10, 2017, which application is incorporated herein by reference as if set forth in its entirety.

### FIELD OF THE INVENTION

This patent application relates generally to robotic arm, and more specifically, to a robotic arm equipped with a rotatable top.

### BACKGROUND

Today's robotic arms generally function within the space of six (6) axes of operation and its freedom of rotation is highly restricted requiring more space for operational freedom.

### SUMMARY OF THE INVENTION

Various embodiments provide a composite structure arranged with a rotatable top. The composite structure is designed in such a way that it is flexible, more agile and user friendly. With improved angles of freedom and ability to be adjusted in multiple positions along six (6) axes, while all the six (6) axes are independent of each other, this provision indeed helps the user to have the composite structure adjusted in every angle that is comfortable for the user. While most of the robotic arms in the market has the provision to be adjusted at different positions according to the use, but the positions that the user has freedom to change are usually limited to three (3) or four (4) for example. But, the disclosed composite structure has no limitation of that kind. The disclosed composite structure can be adjusted at multiple different positions along all six (6) axes and can be locked at any desired position that the user may feel comfortable with, in total contrast to the robotic arms currently in the market.

In one embodiment, a composite structure arranged with a rotatable top, comprises a rotatable top located at the distal end of the composite structure and coupled to a body; the body having one or more sections with a first load bearing section supporting the rotatable top; and a rotatable base coupled to the one or more sections and located at the proximal end of the composite structure thereby forming a flexible architecture; wherein said architecture provides a plurality of degrees of displacement and angles of freedom and the ability to be adjusted in one or more positions along one or more independent axes.

Another embodiment provides an apparatus, which includes a composite structure having a rotatable top at the distal end of the composite structure. The apparatus comprises means for attaching a body having one or more sections with a first load bearing section supporting the rotatable top; means for attaching a rotatable base to the one or more sections and located at the proximal end of the composite structure thereby forming a flexible architecture.

### BRIEF DESCRIPTION OF THE DRAWINGS

The teachings of the present invention can be readily understood by considering the following Detailed Description in conjunction with the accompanying drawings, in which like reference numerals refer to identical or functionally similar elements:

FIG. 1 depicts Isometric and Front views of an exemplary composite structure according to an embodiment;

FIG. 2 depicts Right and Rear views of an exemplary composite structure according to an embodiment;

FIG. 3 depicts Isometric, Right, Front, Bottom and Top views of an exemplary rotatable top according to an embodiment of the composite structure of FIG. 1;

FIG. 4 depicts: (1) Isometric, Top, Rear and Left views of an exemplary side flap and (2) Isometric, Top, Rear, Bottom and Left views of an exemplary knob of a bucket according to an embodiment of the composite structure of FIG. 1;

FIG. 5 depicts Isometric, Rear, Front, Bottom, Right and Left views of a first exemplary front robotic arm mechanism according to an embodiment of the composite structure of FIG. 1;

FIG. 6 depicts: (1) Bottom, and Front views of an exemplary slider shaft and (2) Isometric, Top, Rear, Bottom, Right and Front views of an exemplary first table mount leg of the cylinder base according to an embodiment of the composite structure of FIG. 1;

FIG. 7 depicts: (1) Isometric, Right, Front, Rear and Bottom views of an exemplary slider and (2) Isometric, Bottom and Front views of an exemplary spur gear of the bucket according to an embodiment of the composite structure of FIG. 1;

FIG. 8 depicts Isometric, Rear, Front, Bottom, Top, and Right views of an exemplary rotating arm base mechanism according to an embodiment of the composite structure of FIG. 1;

FIG. 9 depicts: (1) Isometric, Left, Rear, Top and Bottom views of an exemplary knob and (2) Isometric, Bottom, Right, Front and Bottom views of an exemplary mount of the rotatable top according to an embodiment of the composite structure of FIG. 1;

FIG. 10 depicts Isometric, Rear, Front, Bottom, Top, Right and Left views of an exemplary worm gear according to an embodiment of the composite structure of FIG. 1;

FIG. 11 depicts Isometric, Rear, Front, Bottom, Top and Left views of an exemplary cylinder base according to an embodiment of the composite structure of FIG. 1;

FIG. 12 depicts Isometric, Rear, Front, Bottom, Top and Left views of an exemplary table mount according to an embodiment of the composite structure of FIG. 1;

FIG. 13 depicts Isometric, Rear, Front, Bottom, Top, Right and Left views of an exemplary bucket lappy stand upgrade mechanism according to an embodiment of the composite structure of FIG. 1;

FIG. 14 depicts Isometric, Rear, Front, Bottom and Right views of a second exemplary rear robotic hand according to an embodiment of the composite structure of FIG. 1;

FIG. 15 depicts Isometric, Front, Bottom and Left views of an exemplary rotating arm base combiner mechanism according to an embodiment of the composite structure of FIG. 1;

FIG. 16 depicts Isometric, Rear, Front, Bottom, Left and Top views of an exemplary flap/stopper mechanism according to an embodiment of the composite structure of FIG. 1; and

FIG. 17 depicts (1) Isometric, Right, Top and Bottom views of an exemplary bolt holder and (2) Front, Top, Isometric, Right and Rear views of a second bolt holder according to an embodiment of the composite structure of FIG. 1.

The headings provided herein are for convenience only and do not necessarily affect the scope or meaning of the claimed embodiments. Further, the drawings have not necessarily been drawn to scale. For example, the dimensions of some of the elements in the figures may be reduced or expanded to help in understanding the embodiments. Moreover, while the disclosed technology is subject to various modifications and alternative forms, specific embodiments have been shown by way of example in the drawings and are described in detail below. Although various embodiments, which incorporate the teachings of the present invention have been shown and described in detail herein, those skilled in the art can readily devise many other varied embodiments that still incorporate these teachings.

### DETAILED DESCRIPTION

The invention will be primarily described within the context of particular embodiments; however, those skilled in the art and informed by the teachings herein will realize that the invention is also applicable to other technical areas and/or embodiments.

The illustrative embodiments described herein are not meant to be limiting. It may be readily understood that certain aspects of the disclosed embodiments can be arranged and combined in a variety of different configurations, all of which are contemplated herein. In one embodiment, the composite structure is a robotic arm. In other embodiments, the composite structure is a laptop stand. In yet other embodiments, the composite structure is a musical instrument stand. For example, the musical instrument can be a keyboard, piano and the like. In further embodiments, the composite structure is a DJ mixer holder. To illustrate its versatility, the composite structure can be installed on the wall for usage. The composite structure can be configured for a myriad of usage. For example, the composite structure can be used as projector stand, a tablet holder, a book holder, a lamp holder, a phone holder and the like.

Generally speaking, the various embodiments enable, support and/or provide a new paradigm in robotic arm technology. These embodiments disclose a robotic arm, which operates in the space of six (6) axes and more angles of freedom, thereby providing the robotic arm more agility to perform a vast number of functions and requires less operational space, which is a billion dollar solution when it comes to the industrial and manufacturing facilities. For example, the disclosed robotic arm rotates within two (2) 360°-degree angle of freedom, two (2) 180°-degree angles of freedom, two (2) linear moment axes. To further illustrate the operational flexibility of the disclosed robotic arm, consider the following: if a robotic arm is programmed to pick and place an object, the robotic arm will pick the object, which is located in front of it and has to turn 180° degrees horizontally and place the object. In this method of operation, the robotic arm needs 180° degrees around it either left half 180° degrees or right half 180° degrees to be empty and free so that it can rotate 160° degrees horizontally or axially. This method of operation consumes space and takes more time to perform the work. In comparison, the compatible robotic arm will be more agile and can access more critical places to pick and place objects, because it has six (6) axes and more angles of freedom to bend, rotate and revolve around different portions or segments of the robotic arm. A regular robotic arm can rotate horizontally 360° degrees and can make a 90°-degree angular motion (between “x” and “z” axes), this means that the robotic arm cannot pick and place an object from front to back of itself without making a 180° degree horizontal rotation. But, the compatible robotic arm need not have to make a 180°-degree horizontal rotation around the z axis to pick and place an object from front to back, instead the compatible robotic arm makes a required angular motion through the z axis by avoiding consumption of space around it.

Another feature of the compatible robotic arm is its agility to make a linear moment. on “x” (axial) and “z” axis unlike the regular robotic arms. Regular robotic arms have a fixed axis along “z”, and “x” or “y” (longitudinal) axes, but the compatible robotic arm has “x” axis that can make a linear moment along “z” axis. And, “x” axis can long make a linear moment along its own axis. This makes the robotic arm more agile and flexible.

When this compatible robotic arm is mounted on a chassis, which can move from one place to another, it becomes an efficient tool for the armed forces to defend soldiers from enemy fire. Also, the compatible robotic arm is very light in weight and can be easily carried from one place to another and can be mounted on a prescribed or preferred location very quickly.

When this compatible robotic arm is equipped with a night vision camera and other tools, it can help to neutralize the intruders sneaking into a country's borders.

This compatible robotic arm can also be utilized in space science where this compatible robotic arm can be used as legs for locomotion on an uneven terrain. This compatible robotic arm when placed in a certain way in a particular structure in all four corners can be used as legs to locomote and can also help the space rover to go into places where a regular space rover can't go. For example, if a space rower is climbing a hill and at one point loses its balance and capsizes thereby jeopardizing the mission, it is impractical to send a manned mission to the same alien planet to put the space rover back onto its wheels again. But, a space rover equipped with compatible robotic arms on all four of its sizes can actually prevent the space rover from capsize during travel on uneven terrain. At times when the compatible robotic arm isn't able to prevent the rover from capsizing, it can turn the space rover into a sphere enabling the space rover to roll down the hill and, when the rover reaches a complete stop, the compatible robotic arm located at all four sides of the space rover would deploy and help the space rover make another attempt at climbing the hill. This mechanism in fact will be helpful in enabling the rover to make multiple attempts to reach a particular place of high priority on a different alien planet without the fear of the rover being capsized.

In another embodiment, the compatible robotic arm can be used in automatic, manufacturing and assembly facilities. Due to its compatibility, agility and more number of axes of operation and degrees of freedom, the robotic hand consumes or requires less space for its operation when compared to a regular robotic hand. These features in fact helps industries consume less space for its operations and plant capacity can be increased. The disclosed robotic arm can operate manually as well as autonomously.

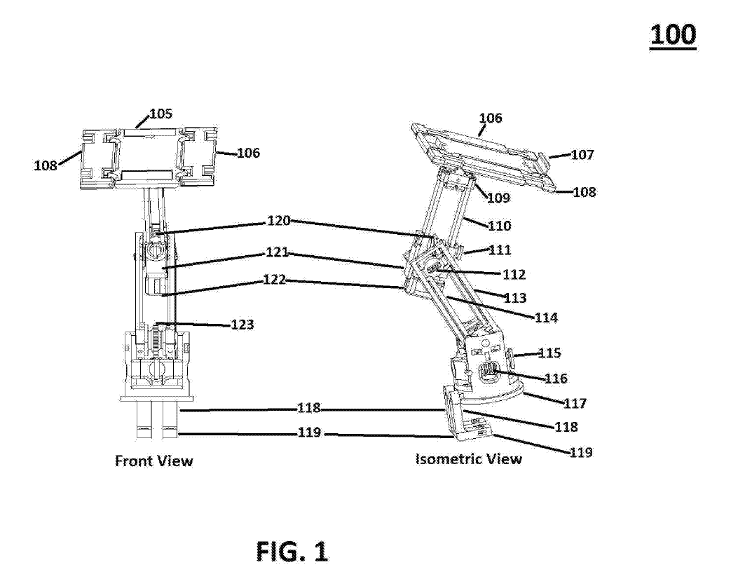

FIGS. 1-17 illustrate a composite structure 100-200 according to various embodiments.

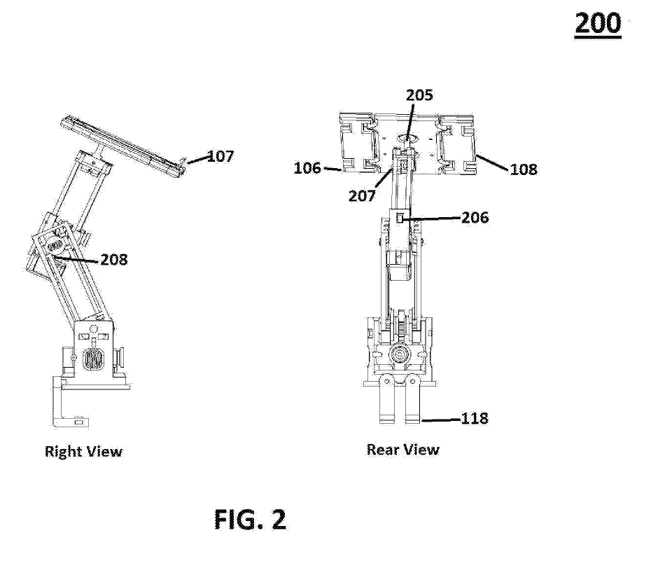

FIG. 1 depicts isometric and Front views of an exemplary composite structure according to an embodiment. FIG. 2 depicts Right and Rear views of an exemplary composite structure according to an embodiment. As shown in FIGS. 1 and 2, the composite structure preferably comprises four (4) major segments namely, (1) cylinder base 117 and its associated parts, (2) first slider 114 and its associated parts; (3) second slider 110 and. its associated parts; and (4) rotatable top 105 and its associated parts.

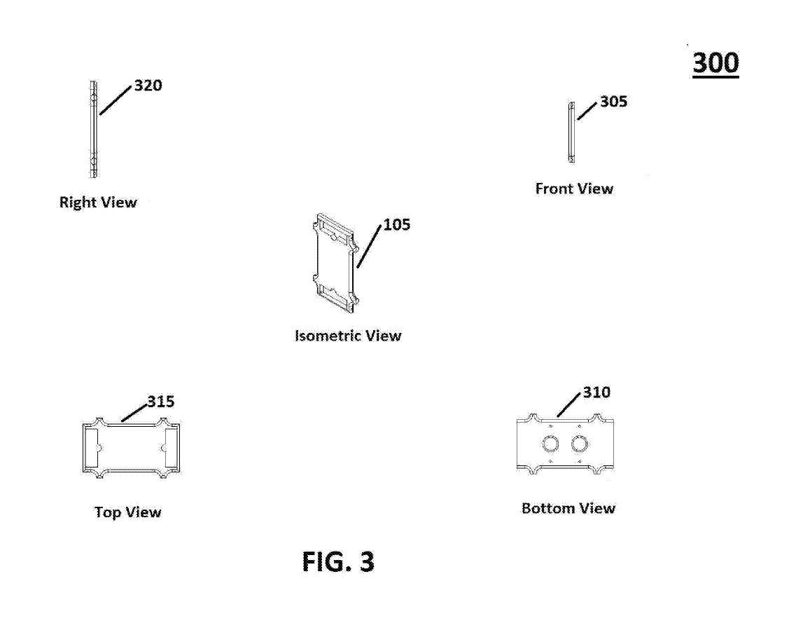

FIG. 3 depicts Isometric, Right, Front, Bottom and Top views of an exemplary rotatable top according to an embodiment of the composite structure of FIG. 1.

Rotatable top 105 constitutes a fourth segment that is formed of four (4) distinct parts namely, top base 105, right side flap 106, left side flap 108, flap/stopper 107 for rotatable top 100. Moreover, right side flap 106 and left side flap 108 are interchangeable.

The first part of top 105 namely, the base is shown in its different views such as front view 305, bottom view 310, top view 315 and right side view 320. In one embodiment, the four (4) distinct parts comprise a first element, a second element and a third element. The three (3) elements preferably implement the rotatable top of(composite structure 100 and are coupled together so form a finished assembly or segment as described above. This finished assembly can be made into any suitable shape or desirable configuration and can manufactured from any suitable material.

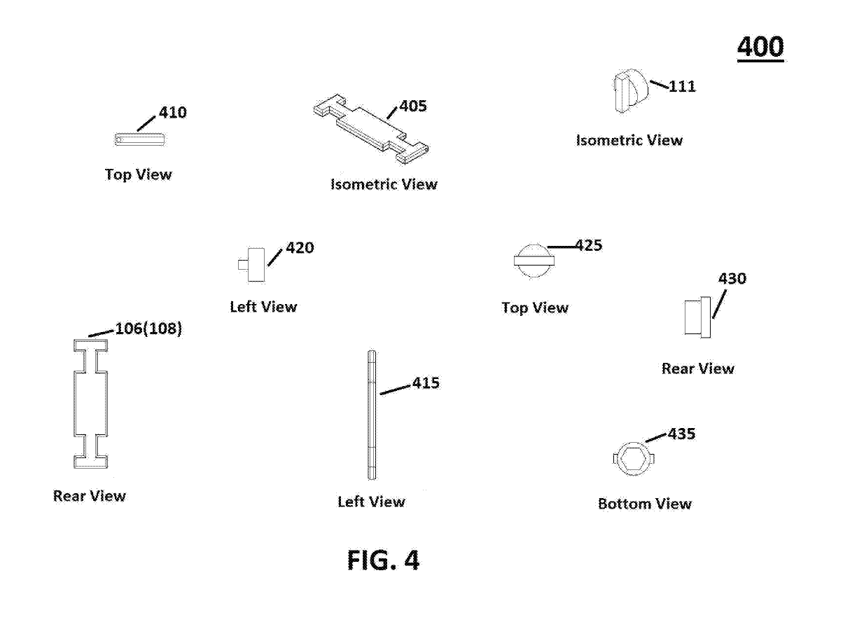

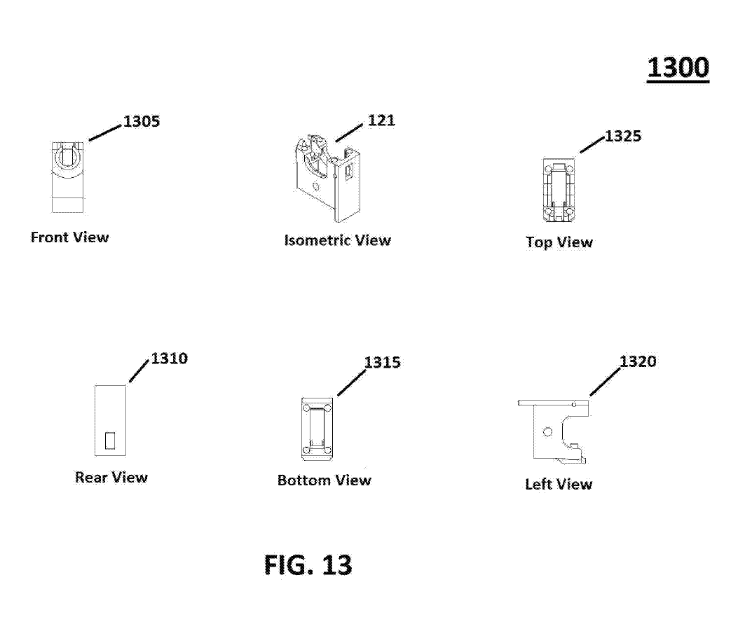

FIG. 4 depicts: (1) Isometric, Top, Rear and Left views of an exemplary side flap and (2) Isometric, Top, Rear, Bottom and Left views of an exemplary knob of bucket 121 according to an embodiment of the composite structure of FIG. 1. In one embodiment, knob 111 is mated with part 121 shown in FIG. 13. Knob 111 along with part 121 are used to as a mechanism to facilitate the functionality of slider 110.

The second part namely, side flaps 106 of rotatable top base 105 is shown in its different views such as isometric view 405, top view 410, left side view 415. The right side view is identical to the left. The bottom view is identical to the top and the front view is identical to the rear. In some embodiment 106 and 108 are two (2) distinct parts with different dimensions and shapes. Also shown in FIG. 4 is knob 111 in its different views such as left side view 420, top view 425, rear view 430 and bottom view 435. The right side view is identical to the left.

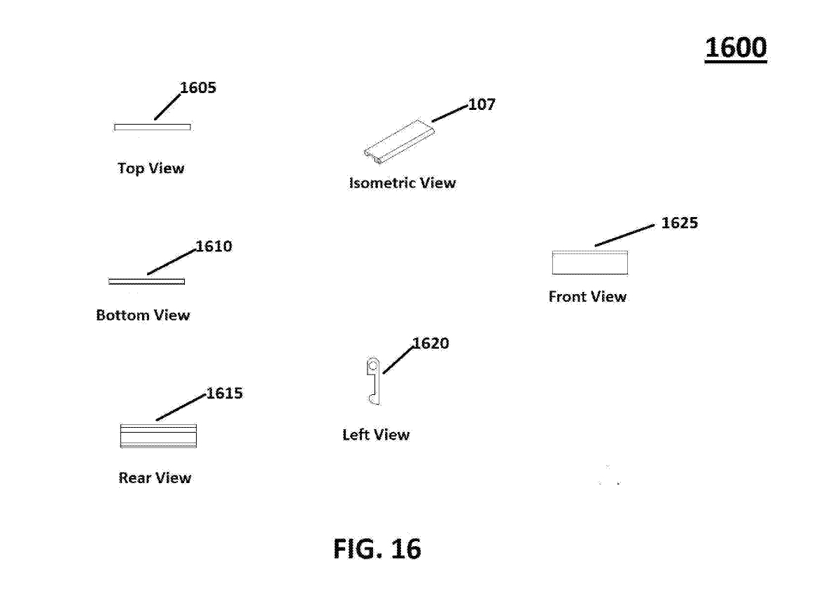

FIG. 16 depicts Isometric, Rear, Front, Bottom, Left and Top views of an exemplary flap/stopper mechanism according to an embodiment of the composite structure of FIG. 1.

The fourth part namely, flap/stopper 107 of rotatable top base 105 is shown in its different views such as isometric view 107, top view 1605, bottom view 1610, rear view 1615, left side view 1620 and front view 1625. The right side view is identical to the left.

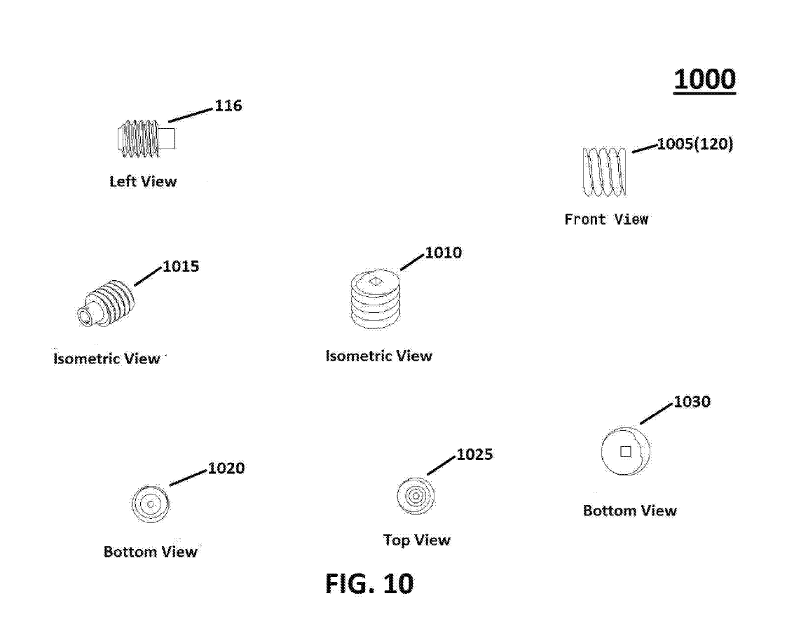

FIG. 10 depicts Isometric, Front, Bottom, Top, Right and. Left views of an exemplary worm gear according to an embodiment of the composite structure of FIG. 1;

Worm gear 120 is shown in its different views such as isometric views 1010 (120), 1015 (116) front view 1005 (120), top view 1025 (116), bottom view 1030 (120), left side view 116. The left side view is identical to the right. The top view is identical to the bottom and the rear view is identical to the front.

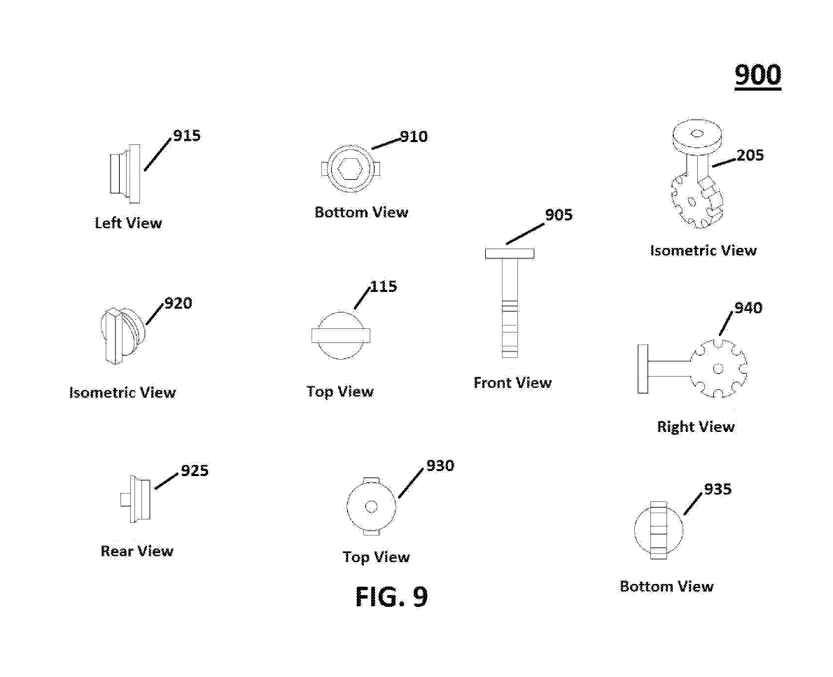

FIG. 9 depicts: (1) Isometric, Left, Rear, Top and Bottom views of an exemplary knob and (2) Isometric, Right, Front and Bottom views of an exemplary mount of the rotatable top according to an embodiment of the composite structure of FIG. 1.

The fifth part namely, mount 205 of rotatable top base 105 is shown in its different views such as isometric view 205, bottom view 935, right side view 940 and front view 905. The left side view is identical to the right. The rear view is identical to the front.

Second slider 110 constitutes a third segment that. is made up of ten (parts) distinct parts namely, front angular motion mechanism 109, shaft 110, knob 111, slider 112, worm gear 120, bucket lappy stand 121, angular motion mechanism or rear robotic hand 122, bolt holder 206, bolt holder 207 and spur gear 208.

In one embodiment, the nine (9) distinct parts comprise a first element, a second element, a third element, a fourth, fifth, sixth and seventh element. The seven (7) elements preferably implement the second slider of composite structure 100 and are coupled together to form a finished assembly or segment as described above. This finished assembly can be made into any suitable shape or desirable configuration and can be manufactured from any suitable material.

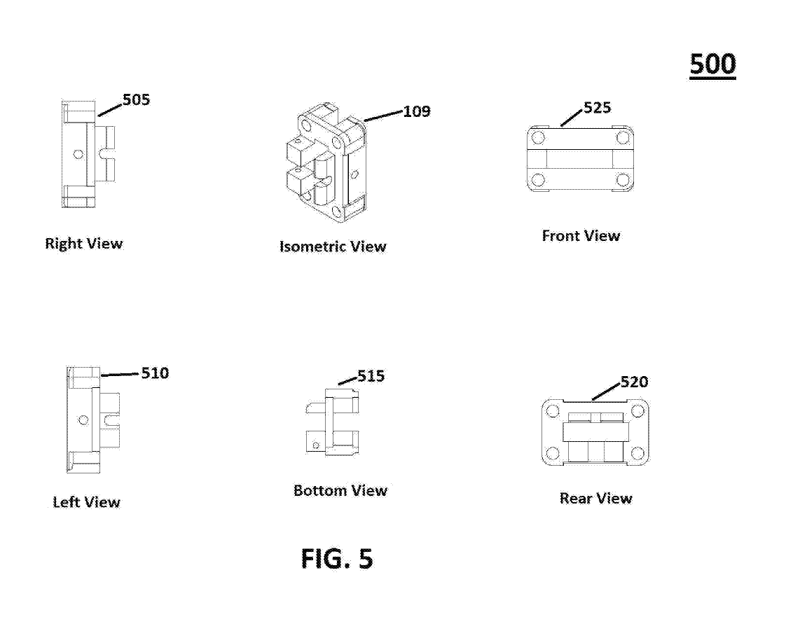

FIG. 5 depicts Isometric, Rear, Front, Bottom, Right and Left views of a first exemplary front robotic arm mechanism according to an embodiment of the composite structure of FIG. 1

The first part of second slider 110 namely, angular motion mechanism 109 is shown in its different views such as isometric view 109, bottom view 515, right side view 505, left side view 510, rear view 520 and front view 525. The top view is identical to the bottom.

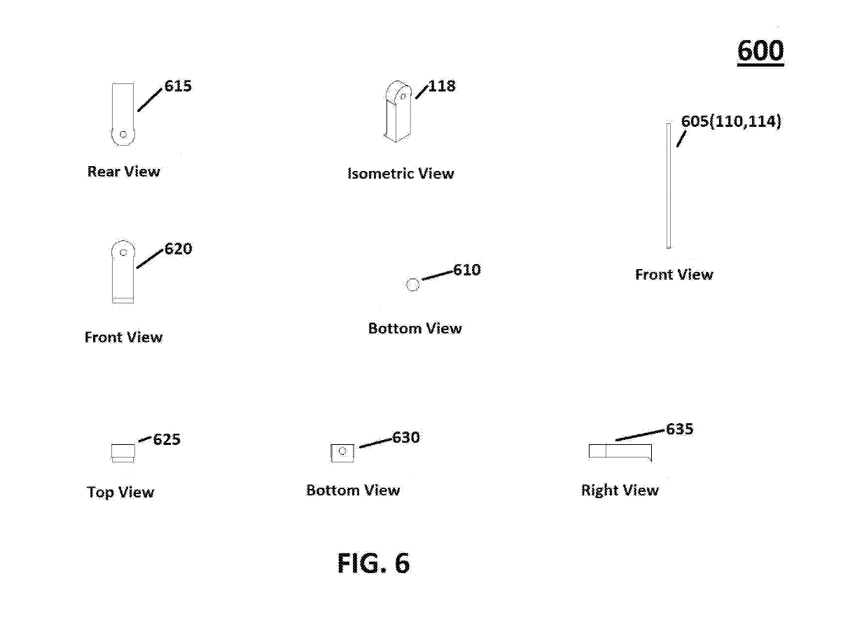

FIG. 6 depicts: (1) Bottom, and Front views of an exemplary slider shaft and (2) Isometric, Top, Rear, Bottom, Right and Front views of an exemplary first table mount leg of the cylinder base according to an embodiment of the composite structure of FIG. 1.

The second part of second slider 110 namely, shaft 110 is shown in its different views such as front view 110 and bottom view 610. The top view is identical to the bottom. The rear view is identical to the front, similarly the right side and left side views are identical to each other. In some embodiments, these shapes are non-symmetrical.

The third part of second slider 110 namely, knob 111 is described above in reference to FIG. 4. Knob 111 is shown in its different views such as isometric view 111, left view 420, top view 425, rear view 430, bottom view 435. The right side view is identical to the left in the front view is identical to the rear view.

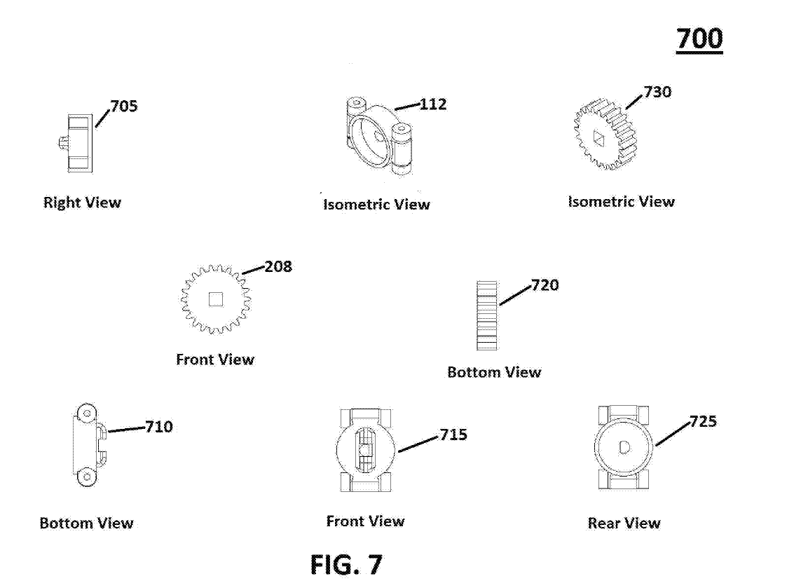

FIG. 7 depicts: (1) Isometric, Right, Front, Rear and Bottom views of an exemplary slider and (2) Isometric, Bottom and Front views of an exemplary spur gear of bucket 121 according to an embodiment of the composite structure of FIG. 1.

The fourth part of second slider 110 namely, slider 112 is shown in its different views such as isometric view 112, right side view 705, bottom view 710, front view 715, bottom view 710 and rear view 725.

The fifth part of second slider 110 namely, worm gear 120 is described in reference to FIG. 10 above.

FIG. 13 depicts Isometric, Rear, Front, Bottom, Top, Right and Left views of an exemplary bucket sappy stand upgrade mechanism according to an embodiment of the composite structure of FIG. 1.

The sixth part of second slider 110 namely, bucket lappy stand 121 is shown in its different views such as isometric view 121, front view 1305, rear view 1310, bottom view 1315, left side view 1320, and top view 1325. The right side view is identical to the left.

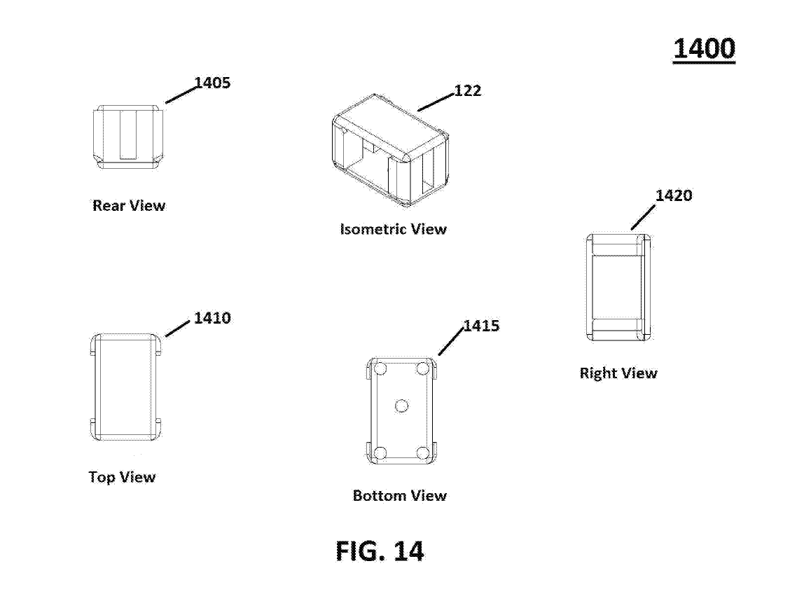

FIG. 14 depicts Isometric, Rear, Bottom, Right and Top views of a second exemplary angular motion mechanism. according to an embodiment of the composite structure of FIG. 1.

The seventh part of second slider 110 namely, angular motion mechanism or robotic hand 122 is shown in its different views such as isometric view 122, rear view 1405, top view 1410, bottom view 1415 and right side view 1420. The left side view is identical to the right and the front view is identical to the rear.

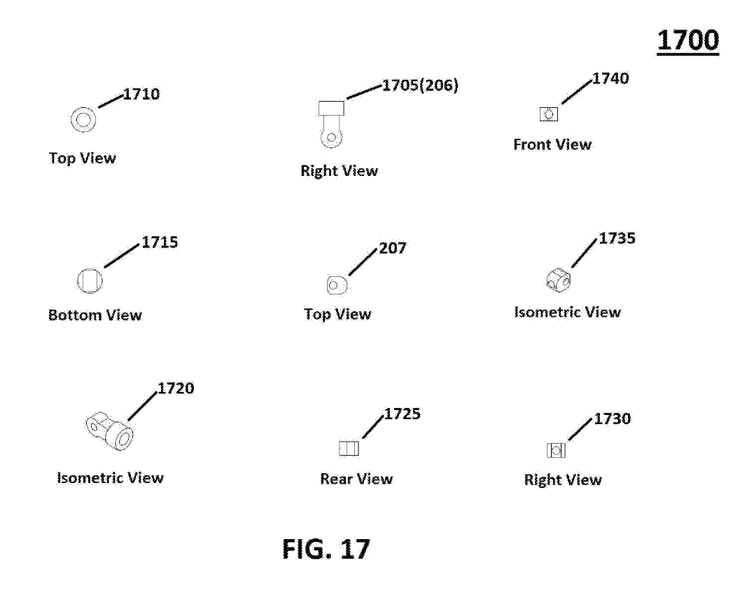

The eight part of second slider 110 namely, bolt holder 207 is discussed in reference to FIG. 17 below and the ninth part namely, spurt gear 208 is discussed in reference to FIG. 7.

The tenth part of second slider 110 namely, bolt holder 206 is discussed in reference to FIG. 17 below.

First slider 114 constitutes the second segment that is made up of three (3) distinct parts namely, rotating arm 113, shaft 114 and rotating arm base combiner 123.

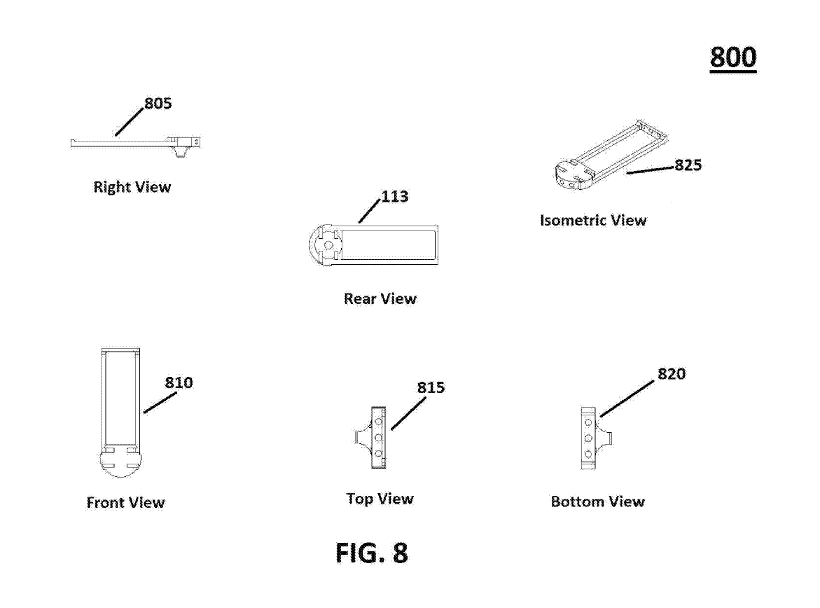

FIG. 8 depicts Isometric, Rear, Front, Bottom, Top, Right and Left views of an exemplary rotating arm base mechanism according to an embodiment of the composite structure of FIG. 1;

The first part of first slider 114 namely, rotating arm base 113 is shown in its different views such as isometric view 825, front view 810, rear view 113, top view 815, bottom view 820, right side view 805 and isometric view 825. The left side view is identical to the right.

The second part of first slider 114 namely, shaft 114 is discussed above in reference to FIG. 6.

FIG. 17 depicts Isometric, Left, Front, Rear, Top and Bottom views of an exemplary bolt holder according to an embodiment of the composite structure of FIG. 1.

Bolt holder 206 and its analog 207 are shown in its different views such as isometric views 1720 (207) and 1735 (206), top views 1710 (206) and 207, right views 1705 (206) and 1730 (207), and bottom view 1715(207. The left views are identical to counterpart right view and so on.

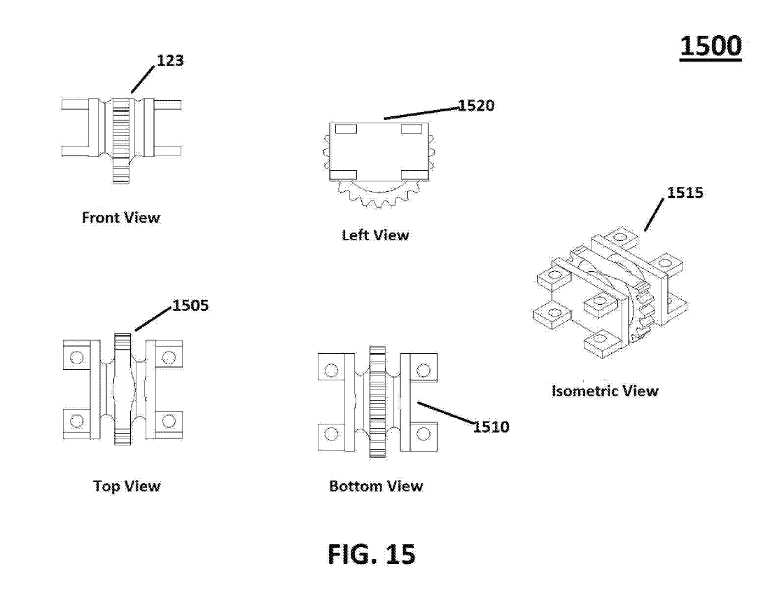

The third part namely, rotating arm base 123 is discussed in reference to FIG. 15 below.

Cylinder base 117 constitutes the first segment that is made up of four (4) distinct parts namely, knob 115, worm gear 116, cylinder base 117, table mounts 118 and 119.

In one embodiment, the five (5) distinct parts comprise a first element and a second element. The two (2) elements preferably implement rotatable base 117 of composite structure 100 and are coupled together to form a finished assembly or segment as described above. This finished assembly can be made into any suitable shape or desirable configuration and can be manufactured from any suitable material.

The first part of cylinder base 117 namely, knob 115 is described above in reference to FIG. 9.

The second part of cylinder base 117 namely, worm gear 116 is described above in reference to FIG. 10.

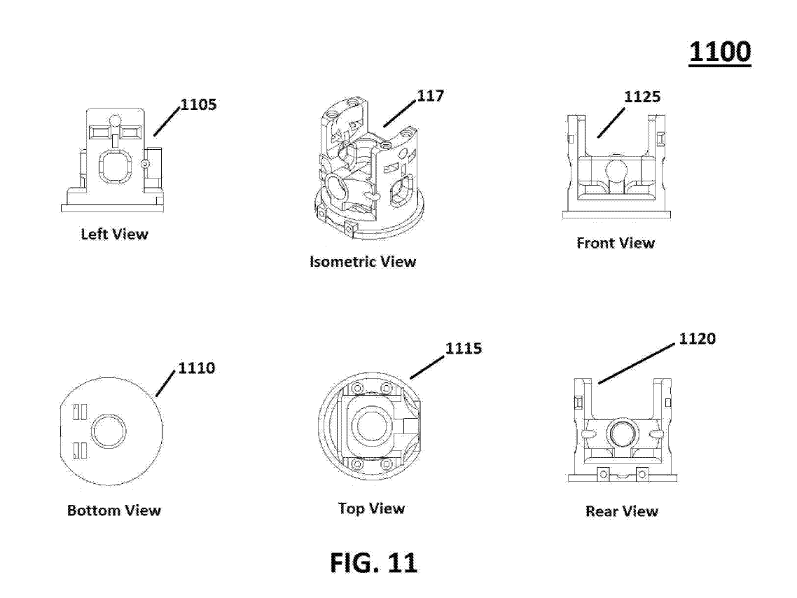

FIG. 11 depicts Isometric, Rear, Front, Bottom, Top and Left views of an exemplary cylinder base according to an embodiment of the composite structure of FIG. 1.

The third part of cylinder base 117 namely, cylinder base 117 is shown in its different views such as isometric view 117, left view 1105, bottom view 1110, top view 1115, rear view 1120 and front view 1125. The right view is identical to the lea.

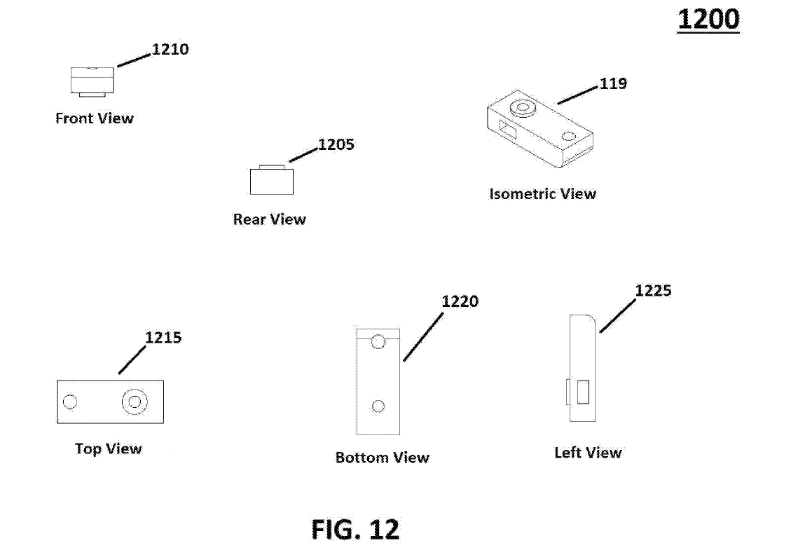

The fourth part of cylinder base 117 namely, table mount leg_1 118 and table mount leg_2 119 are shown in FIG. 6 and FIG. 12 as discussed above. The two parts are identical. The views shown are isometric view 118, rear view 615, front view 620, top, view 625, bottom view 630 and right view 635. In some embodiment, the two parts differ. For example, one part may be adjustable while the other is fixed. As the name implies, the table mount is used to mount composite structure 100.

FIG. 15 depicts Isometric, Rear, Front, Bottom, Right and Left views of an exemplary rotating arm base mechanism according to an embodiment of the composite structure of FIG. 1.

Rotating arm base 123 is shown in its different views such. as front view 123, top view 1505, bottom view 1510, isometric view 1515 and left view 1520. The rear view is identical to the front and the right view is identical to the left view.

As described above, composite structure 100 preferably comprises has a cylinder base 117, first slider 114, second. slider 110 and rotatable top 105. Both sliders also serve as load bearing sections. Moreover, the segments of composite structure are arranged or coupled. in a manner that induces an interdependency relationship. Stated differently, the segments are both dependent and independent of each other. For example, cylinder base 117 is independent, which means its position is affected by other segments position or orientation.

Cylinder base 117 remains stationary all the time. However, if cylinder base 117 moves, first slider 114 moves along, the axis of cylinder base 117; second slider 110 also moves along the axis of cylinder base 117; and rotatable top 105 also moves along the same axis. In one embodiment, cylinder base 117 has a cap on each side (not shown) to facilitate insertion of slider 114 into cylinder base 117.

First slider 114 is independent, but not stationary unlike cylinder base 117. However, if the position or orientation of first slider 114 is changed, then second slider 110 and rotatable top 105 will also move with first slider 114, because second slider 110 and rotatable top 105 are physically connected with first slider 114. Additionally, the position of second slider 110 and rotatable top 105 will remain constant and will not change until the user decides to make changes to the positions of the segments.

Second slider 110 causes rotatable top 105 to be dependent upon it. If the position of second slider 110 is changed, then rotatable top 105 will also be affected.

Rotatable top 105 is dependent upon the other three (3) segments. If rotatable top 105 alone moves none of the other segments are affected.

Composite structure 100 is architected to encompass a total of six (6) axes including angular motion and linear displacement. Cylinder base 117 is located at the proximal end of composite structure 100 and therefore, the first axis or axis-1 is referenced at a point, which lies on the cylinder base. This axis provides an angular moment of 180° degrees of freedom translating into 90° degree to the front and 90° degree back. And, the desired position can be maintained using the mechanism of worm gear 116 and spur gear 123 given that worm gear and spur gear can be used as locking mechanism. In one embodiment, worm gear 116 has a knob 115. In one embodiment, whenever the user wants to hold to a certain position at a specific angle, the user should gently push the knob up and turn it clockwise to tighten the knob. Secondly, if the user decides to change the angle, then the user should unscrewed a knob from the locking position thereby releasing the knob down to change the position as desired. In order embodiment, this process is automated.

First slider 114 is coupled to cylinder base 117. Accordingly, first slider 114 constitutes the second axis or axis-2. This axis is used to cause a vertical linear moment or longitudinally (up and down) to make comfortable adjustment according to the user's the height or sitting posture. This axis serves as a quick adjustment because it allows sliding movement vertically up and down thereby providing a quick adjustment in terms of height. To adjust this axis, a user should lift rotatable top 105 slightly and allow rotatable top 105 to come to an equilibrium point. Secondly, if the user wants to slide rotatable top 105 vertically the user should hold said top and gently pull up and allow rotatable top 105 to come to an equilibrium point.

A third axis is associated with first slider 110. This axis is used to rotate first slider 114. This axis has 360° degrees angle of freedom. First slider 114 being the second major segment can remain constant through the use of worm gear 120 and spur gear 208 combination. As explained above, worm gear is coupled to the knob, which is used to lock onto the spur gear whenever the position of slider 114 has to remain constant. If the user wants to hold the position at a specific angle, the user should. gently push the knob of in turn it clockwise to tighten the knob. Secondly, if the user decides to change the angle then the user should unscrewed in the knob from the locking position to thereby release it down to change the position as desired. In an embodiment, this process is automated. In other embodiments, the third axis is implemented using second slider 110. Yet, in some embodiments the third axis implemented using a combination of first slider 114 and second slider 110.

Second slider 110 is coupled to first slider 114. Accordingly, second slider 110 constitutes the fourth axis or axis-4. This axis is used to implement a linear horizontal or axial moment using second slider 110 to adjust the distance of rotatable top 105 from the user. In order to perform such adjustment, a user should lift rotatable top 105 and push said top gently away and allow said top to come to an equilibrium position. And, second slider 110 will remain at the position where the user stopped sliding said slider. Secondly, if the user wants to slide rotatable top 105 away from him or her then the user should lift rotatable top 105 of in pools said top towards the user and allow said top come to an equilibrium position. And, second slider 110 will remain at the position where the user stopped sliding said slider. In some embodiments, this process is automated.

Rotatable top 105 is coupled to second slider 110. As such, rotatable top 105 constitutes the fifth axis or axis-5. This axis is used to position rotatable top 105 at the desired position. The angle of freedom for this axis is 180° degrees translating into a 90° degree angular motion and 90° degree axial displacement. The position of rotatable top 105 can be made consistent using a knob that lacks the axis to at least six (6) desired locations. In some embodiments, this process is automated.

The sixth axis or axis-6 is used to rotate rotatable top 105 around the axis such that rotatable top 105 would simply swirl around in a spiraling pattern. The angle of freedom for this axis is 360° degrees.

Finally, the language used in the specification has been principally selected for readability and instructional purposes, and it may not have been selected to delineate or circumscribe the inventive subject matter. It is therefore, intended that the scope of the invention be limited not by this detailed description, but rather by any claims that issue on an application based hereon.

Although various embodiments, which incorporate the teachings of the present invention have been shown and described in detail herein, those skilled in the art can readily devise many other varied embodiments that still incorporate these teachings.

We claim:

1. A composite structure arranged with a rotatable top, comprising:
a rotatable top located at the distal end of the composite structure and coupled to a body;
the body having one or more sliders with a first load bearing slider supporting the rotatable top; and
a base coupled to the one or more sections and located at the proximal end of the composite structure thereby forming a flexible architecture;
wherein said architecture provides a plurality of degrees of displacement and angles of freedom and the ability to be adjusted in one or more positions along one or more independent axes.

2. The composite structure of claim 1, wherein the rotatable top is a laptop stand.

3. The composite structure of claim 2, wherein the rotatable top is an iPad holder.

4. The composite structure of claim 2, wherein the rotatable top is a musical instrument stand.

5. The composite structure of claim 4, wherein the rotatable top is a DJ mixer holder.

6. The composite structure of claim 1, wherein the rotatable top is a tablet holder.

7. The composite structure of claim 1, wherein the one or more sections comprise a second load bearing section attached to the rotatable base.

8. The composite structure of claim 1, wherein the one or more sections provide linear moment in the axial and longitudinal axes.

9. An apparatus comprising a composite structure arranged with a rotatable top, including:
means for attaching a rotatable top at the distal end of the composite structure;
means for attaching a body having one or more sections with a first load bearing section supporting the rotatable top;
means for attaching a base to the one or more sections and located at the proximal end of the composite structure thereby forming a flexible architecture.

10. An article of manufacture, comprising:
a composite structure arranged with a rotatable top, comprising:
a rotatable top attached at the distal end of the composite structure;
a body having one or more sections with a first load bearing section supporting the rotatable top; and
a base attached to the one or more sections and located at the proximal end of the composite structure thereby forming a flexible architecture;
wherein said architecture provides a plurality of degrees of displacement and angles of freedom and the ability to be adjusted in one or more positions along one or more independent axes.
